(19) United States
(12) Patent Application Publication
(10) Pub. No.: US 2026/0261931 A1
(43) Pub. Date: Sep. 3, 2026

(54) INFORMATION TRANSMISSION METHOD AND APPARATUS, AND STORAGE MEDIUM

(71) Applicant: Beijing Xiaomi Mobile Software Co., Ltd., Beijing (CN)

(72) Inventor: Wei HONG, Beijing (CN)

(73) Assignee: Beijing Xiaomi Mobile Software Co., Ltd., Beijing (CN)

(21) Appl. No.: 18/858,113

(22) PCT Filed: Apr. 21, 2022
(86) PCT No.: PCT/CN2022/088268

§ 371 Date: Oct. 18, 2024

(51) Int. Cl. H04W 36/08; H04W 64/00; H04W 76/10; H04W 76/20; H04W 84/06

(52) U.S. Cl. CPC H04W 36/08; H04W 64/00; H04W 76/10; H04W 76/20; H04W 84/06

(57) ABSTRACT

Information transmission methods and apparatuses, and storage mediums are provided. The information transmission method comprises: determining, in response to determining that cell reselection has been performed, a base station to be accessed after the cell reselection; and reporting flight path information of the first unmanned aerial vehicle to the base station. The present application reduces the possibility of unmanned aerial vehicles colliding during a flight, can avoid economic loss, and greatly increases the availability of unmanned aerial vehicles.

### CROSS-REFERENCE TO RELATED APPLICATIONS

The present disclosure is a U.S. national phase of PCT Application No. PCT/CN2022/088268 filed on Apr. 21, 2022, the content of which is hereby incorporated by reference in its entirety.

### TECHNICAL FIELD

The present disclosure relates to a field of communication, and in particular, to information transmission methods and apparatuses, and storage mediums.

### BACKGROUND

An unmanned-driven aerial vehicle is referred to as an unmanned aerial vehicle (UAV) for short and is an unmanned aircraft that is manipulated by a radio remote control device and a self-contained program control apparatus. The unmanned aerial vehicle is actually a general term for unmanned aircrafts, and may include from a technical perspective: an unmanned fixed-wing aircraft, an unmanned vertical take-off and landing aircraft, an unmanned airship, an unmanned helicopter, an unmanned multi-rotor aircraft, an unmanned umbrella wing aircraft, and the like.

With rapid development of unmanned aerial vehicle technologies, reduction of cost, and improvement of functions, the unmanned aerial vehicles are increasingly applied to ordinary consumers. The application of the unmanned aerial vehicles in industries is a true necessity for the unmanned aerial vehicles. At present, the application of the unmanned aerial vehicles in fields, such as aerial photography, agriculture, plant protection, micro self-shooting, express transportation, disaster rescue, wild animal observation, infectious disease monitoring, surveying and mapping, news reporting, electric power inspection, disaster relief, film and television shooting, creating romance, and the like, has greatly expanded the use of the unmanned aerial vehicles. Various countries are actively expanding industry applications and developing the unmanned aerial vehicle technologies.

In order to further expand an application range of the unmanned aerial vehicle, a 3rd generation partnership project (3GPP) has approved an item of enhanced support for unmanned aerial vehicles. The item is intended to study and standardize how to enable a 5th generation mobile communication technology (5G) network to provide the unmanned aerial vehicles with services meeting requirements.

### SUMMARY

Embodiments of the present disclosure provide information transmission methods and apparatuses, and storage mediums.

According to a first aspect of embodiments of the present disclosure, an information transmission method is provided. The method is performed by a first unmanned aerial vehicle and includes: determining, in response to determining that cell reselection has been performed, a base station to be accessed after the cell reselection; and reporting flight path information of the first unmanned aerial vehicle to the base station.

According to a second aspect of embodiments of the present disclosure, an information transmission method is provided. The method is performed by a base station and includes: receiving flight path information of a first unmanned aerial vehicle reported by the first unmanned aerial vehicle; where the first unmanned aerial vehicle is an unmanned aerial vehicle that is to access the base station after performing cell reselection; and sending the flight path information of the first unmanned aerial vehicle to a second unmanned aerial vehicle; where the second unmanned aerial vehicle is an unmanned aerial vehicle that has accessed the base station.

According to a third aspect of embodiments of the present disclosure, an information transmission method is provided. The method is performed by a second unmanned aerial vehicle and includes: receiving flight path information of a first unmanned aerial vehicle sent by a base station; where the first unmanned aerial vehicle is an unmanned aerial vehicle that is to access the base station after performing cell reselection; and performing, based on the flight path information of the first unmanned aerial vehicle, an operation to avoid a collision with the first unmanned aerial vehicle.

According to a fourth aspect of embodiments of the present disclosure, a non-transitory computer readable storage medium is provided. The non-transitory computer readable storage medium stores a computer program, and the computer program is configured to perform any one information transmission method in the first aspect.

According to a fifth aspect of embodiments of the present disclosure, a non-transitory computer readable storage medium is provided. The non-transitory computer readable storage medium stores a computer program, and the computer program is configured to perform any one information transmission method in the second aspect.

According to a sixth aspect of embodiments of the present disclosure, a non-transitory computer readable storage medium is provided. The non-transitory computer readable storage medium stores a computer program, and the computer program is configured to perform any one information transmission method in the third aspect.

According to a seventh aspect of embodiments of the present disclosure, an information transmission apparatus is provided. The apparatus includes: a processor, and a memory configured to store instructions executable by the processor; where the processor is configured to perform any one information transmission method in the first aspect.

According to an eighth aspect of embodiments of the present disclosure, an information transmission apparatus is provided. The apparatus includes: a processor, and a memory configured to store instructions executable by the processor; where the processor is configured to perform any one information transmission method in the second aspect.

According to a ninth aspect of embodiments of the present disclosure, an information transmission apparatus is provided. The apparatus includes: a processor, and a memory configured to store instructions executable by the processor; where the processor is configured to perform any one information transmission method in the third aspect.

It should be understood that the general description and the detailed description in the following text are only exemplary and explanatory, and cannot limit the present disclosure.

### BRIEF DESCRIPTION OF DRAWINGS

The accompanying drawings here are incorporated into the specification and form a part of this specification, show embodiments conforming to the present disclosure and are used together with the specification to explain principles of the present disclosure.

FIG. 1 is a schematic flowchart of an information transmission method shown according to an exemplary embodiment.

FIG. 2 is a schematic flowchart of another information transmission method shown according to an exemplary embodiment.

FIG. 3 is a schematic flowchart of another information transmission method shown according to an exemplary embodiment.

FIG. 4 is a schematic flowchart of another information transmission method shown according to an exemplary embodiment.

FIG. 5 is a schematic flowchart of another information transmission method shown according to an exemplary embodiment.

FIG. 6 is a schematic flowchart of another information transmission method shown according to an exemplary embodiment.

FIG. 7 is a schematic flowchart of another information transmission method shown according to an exemplary embodiment.

FIG. 8 is a schematic flowchart of an information transmission method shown according to an exemplary embodiment.

FIG. 9 is a schematic flowchart of another information transmission method shown according to an exemplary embodiment.

FIG. 10 is a schematic flowchart of another information transmission method shown according to an exemplary embodiment.

FIG. 11 is a schematic flowchart of another information transmission method shown according to an exemplary embodiment.

FIG. 12 is a schematic flowchart of another information transmission method shown according to an exemplary embodiment.

FIG. 13 is a schematic flowchart of another information transmission method shown according to an exemplary embodiment.

FIG. 14 is a schematic flowchart of another information transmission method shown according to an exemplary embodiment.

FIG. 15 is a schematic flowchart of an information transmission method shown according to an exemplary embodiment.

FIG. 16 is a schematic flowchart of another information transmission method shown according to an exemplary embodiment.

FIG. 17 is a schematic flowchart of another information transmission method shown according to an exemplary embodiment.

FIG. 18 is a schematic flowchart of another information transmission method shown according to an exemplary embodiment.

FIG. 19 is a schematic flowchart of another information transmission method shown according to an exemplary embodiment.

FIG. 20 is a schematic flowchart of another information transmission method shown according to an exemplary embodiment.

FIG. 21 is a schematic flowchart of another information transmission method shown according to an exemplary embodiment.

FIG. 22 is a block diagram of an information transmission apparatus shown according to an exemplary embodiment.

FIG. 23 is a block diagram of another information transmission apparatus shown according to an exemplary embodiment.

FIG. 24 is a block diagram of another information transmission apparatus shown according to an exemplary embodiment.

FIG. 25 is a schematic structural diagram of an information transmission apparatus shown according to an exemplary embodiment of the present disclosure.

FIG. 26 is a schematic structural diagram of another information transmission apparatus shown according to an exemplary embodiment of the present disclosure.

FIG. 27 is a schematic structural diagram of another information transmission apparatus shown according to an exemplary embodiment of the present disclosure.

### DETAILED DESCRIPTION

Exemplary embodiments will be described in details herein, with examples thereof represented in the accompanying drawings. When the following description involves the accompanying drawings, same numerals in different figures represent same or similar elements unless otherwise indicated. Implementations described in the following exemplary embodiments do not represent all implementations consistent with the present disclosure. Rather, they are merely examples of apparatuses and methods consistent with some aspects of the present disclosure as detailed in the appended claims.

Terms used in the present disclosure are only for a purpose of describing specific embodiments, and are not intended to limit the present disclosure. Singular forms, “a/an,” “the,” and “this,” used in the present disclosure and the appended claims are also intended to include majority forms, unless the context clearly indicates other meanings. It should also be understood that the term “and/or” used herein refers to and includes any or all possible combinations of at least one related listed item.

It should be understood that although terms, such as “first,” “second,” “third,” etc., may be used in the present disclosure to describe various information, such information should not be limited by these terms. These terms are only used to distinguish a same type of information from each other. For example, without departing from the scope of the present disclosure, first information may also be referred to as second information, and similarly, the second information may also be referred to as the first information. Depending on the context, the term “if” used herein may be interpreted as “when,” “while,” or “in response to determining.”

The information transmission method provided in the present disclosure is described firstly from a side of a first unmanned aerial vehicle below.

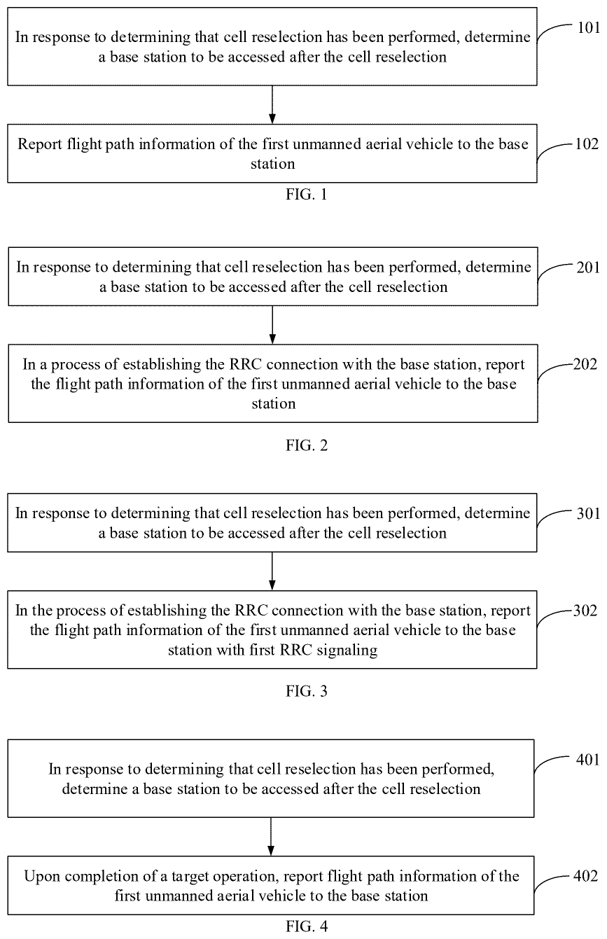

An embodiment of the present disclosure provides an information transmission method. Referring to FIG. 1, FIG. 1 is a flowchart of an information transmission method shown according to an embodiment. The method may be performed by a first unmanned aerial vehicle. Herein, the first unmanned aerial vehicle may be a 5G unmanned aerial vehicle that has just performed cell reselection. The method may include the following steps 101-102.

At step 101, in response to determining that cell reselection has been performed, a base station to be accessed after the cell reselection is determined.

In an embodiment of the present disclosure, the first unmanned aerial vehicle may be in an idle state or an inactive state. The first unmanned aerial vehicle performs cell reselection during flight, and determines a base station to be accessed after the cell reselection.

At step 102, flight path information of the first unmanned aerial vehicle is reported to the base station.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be a height, of the unmanned aerial vehicle at a time point, of the flight path information of the unmanned aerial vehicle, may be an absolute height, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

In the embodiment, after the first unmanned aerial vehicle performs the cell reselection, the first unmanned aerial vehicle reports the flight path information of the first unmanned aerial vehicle to a base station to be accessed after the cell reselection. Therefore, the base station subsequently sends the flight path information of the first unmanned aerial vehicle to a second unmanned aerial vehicle, and the second unmanned aerial vehicle performs an operation to avoid a collision with the first unmanned aerial vehicle after receiving the flight path information. A possibility of the mutual collision between the unmanned aerial vehicles during the flight is reduced, the economic loss is avoided, and the availability of the unmanned aerial vehicle is greatly expanded.

In some optional embodiments, referring to FIG. 2, FIG. 2 is a flowchart of an information transmission method shown according to an embodiment. The method may be performed by a first unmanned aerial vehicle. Herein, the first unmanned aerial vehicle may be a 5G unmanned aerial vehicle that has just performed cell reselection. The method may include the following steps 201-202.

At step 201, in response to determining that cell reselection has been performed, a base station to be accessed after the cell reselection is determined.

In an embodiment of the present disclosure, the first unmanned aerial vehicle may be in an idle state or an inactive state. The first unmanned aerial vehicle performs cell reselection during flight, and determines a base station to be accessed after the cell reselection.

At step 202, in a process of establishing a radio resource control (RRC) connection with the base station, the flight path information of the first unmanned aerial vehicle is reported to the base station.

In the embodiment of the present disclosure, after the first unmanned aerial vehicle determines the base station to be accessed, the first unmanned aerial vehicle may report the flight path information of the first unmanned aerial vehicle to the base station, in the process of establishing the RRC connection with the base station.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle. In the embodiment, the first unmanned aerial vehicle may report the flight path information of the first unmanned aerial vehicle to the base station, in the process of establishing the RRC connection with the base station. The possibility of the mutual collision between the unmanned aerial vehicles during the flight is reduced, the economic loss is avoided, and the availability of the unmanned aerial vehicle is greatly expanded.

In some optional embodiments, referring to FIG. 3, FIG. 3 is a flowchart of an information transmission method shown according to an embodiment. The method may be performed by a first unmanned aerial vehicle. Herein, the first unmanned aerial vehicle may be a 5G unmanned aerial vehicle that has just performed cell reselection. The method may include the following steps 301-302.

At step 301, in response to determining that cell reselection has been performed, a base station to be accessed after the cell reselection is determined.

In an embodiment of the present disclosure, the first unmanned aerial vehicle may be in an idle state or an inactive state. The first unmanned aerial vehicle performs cell reselection during flight, and determines a base station to be accessed after the cell reselection.

At step 302, in the process of establishing the RRC connection with the base station, the flight path information of the first unmanned aerial vehicle is reported to the base station with first RRC signaling.

In the embodiment of the present disclosure, the first RRC signaling may multiplex existing RRC signaling in a protocol, or may be RRC signaling newly defined in the protocol, which is not limited in the present disclosure.

In a possible implementation, in the case where the first RRC signaling multiplexes the existing RRC signaling in the protocol, the first RRC signaling may multiplex RRC signaling related to the random access process.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle. In the embodiment, the first unmanned aerial vehicle may report the flight path information of the first unmanned aerial vehicle to the base station with the first RRC signaling, in the process of establishing the RRC connection with the base station. The possibility of the mutual collision between the unmanned aerial vehicles during the flight is reduced, the economic loss is avoided, and the availability of the unmanned aerial vehicle is greatly expanded.

In some optional embodiments, the first RRC signaling may be to carry a target message for a random access process.

In a possible implementation, the target message may be a message 3. The message 3 may be a related request message that is sent by the first unmanned aerial vehicle serving as user equipment (or terminal) to the base station in the random access process and is for initiating the random access process.

Correspondingly, the first RRC signaling may be any one of: RRC reestablishment request signaling, RRC resume request signaling, or RRC setup request signaling.

In another possible implementation, the target message is a message 5. The message 5 may be sent by the first unmanned aerial vehicle serving as the user equipment to the base station in the random access process and be for notifying the base station that the random access process is completed.

Correspondingly, the first RRC signaling is any one of: RRC reconfiguration complete signaling, RRC reestablishment complete signaling, RRC resume complete signaling, or RRC setup complete signaling.

In the embodiment, the first RRC signaling may multiplex the existing RRC signaling in the protocol, which is easy to implement and has high availability.

In some optional embodiments, referring to FIG. 4, FIG. 4 is a flowchart of an information transmission method shown according to an embodiment. The method may be performed by a first unmanned aerial vehicle. Herein, the first unmanned aerial vehicle may be a 5G unmanned aerial vehicle that has just performed cell reselection. The method may include the following steps 401-402.

At step 401, in response to determining that cell reselection has been performed, a base station to be accessed after the cell reselection is determined.

In an embodiment of the present disclosure, the first unmanned aerial vehicle may be in an idle state or an inactive state. The first unmanned aerial vehicle performs cell reselection during flight, and determines a base station to be accessed after the cell reselection.

At step 402, upon completion of a target operation, flight path information of the first unmanned aerial vehicle is reported to the base station.

In the embodiment of the present disclosure, the target operation is an operation associated with an RRC connection between the first unmanned aerial vehicle and the base station.

In a possible implementation, the target operation includes but is not limited to any one of: an RRC connection establishment operation, an RRC connection reestablishment operation, an RRC restart operation, or an RRC reconfiguration operation.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle. In the embodiment, after the first unmanned aerial vehicle completes the target operation, the first unmanned aerial vehicle may report the flight path information of the first unmanned aerial vehicle to the base station. The possibility of the mutual collision between the unmanned aerial vehicles during the flight is reduced, the economic loss is avoided, and the availability of the unmanned aerial vehicle is greatly expanded.

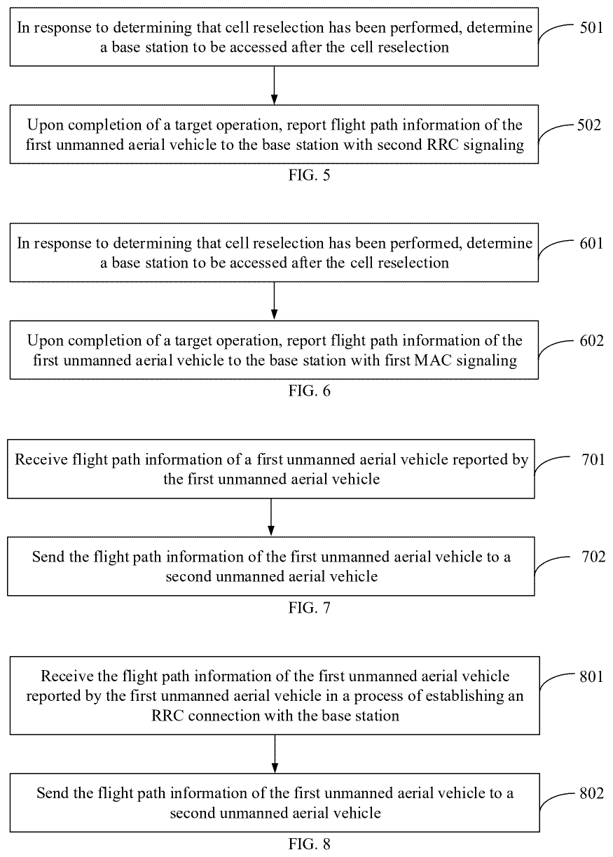

In some optional embodiments, referring to FIG. 5, FIG. 5 is a flowchart of an information transmission method shown according to an embodiment. The method may be performed by a first unmanned aerial vehicle. Herein, the first unmanned aerial vehicle may be a 5G unmanned aerial vehicle that has just performed cell reselection. The method may include the following steps 501-502.

At step 501, in response to determining that cell reselection has been performed, a base station to be accessed after the cell reselection is determined.

In an embodiment of the present disclosure, the first unmanned aerial vehicle may be in an idle state or an inactive state. The first unmanned aerial vehicle performs cell reselection during flight, and determines a base station to be accessed after the cell reselection.

At step 502, upon completion of a target operation, flight path information of the first unmanned aerial vehicle is reported to the base station with second RRC signaling.

In the embodiment of the present disclosure, the target operation is an operation associated with an RRC connection between the first unmanned aerial vehicle and the base station.

In a possible implementation, the target operation includes but is not limited to any one of: an RRC connection establishment operation, an RRC connection reestablishment operation, an RRC restart operation, or an RRC reconfiguration operation.

In the embodiment of the present disclosure, the second RRC signaling may multiplex existing RRC signaling in the protocol, or may be RRC signaling newly defined in the protocol, which is not limited in the present disclosure.

In a possible implementation, in the case where the second RRC signaling multiplexes the existing RRC signaling in the protocol, the second RRC signaling may be specifically UE assistance information signaling.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle. In the embodiment, after the first unmanned aerial vehicle completes the target operation, the first unmanned aerial vehicle may report the flight path information of the first unmanned aerial vehicle to the base station with the second RRC signaling. The possibility of the mutual collision between the unmanned aerial vehicles during the flight is reduced, the economic loss is avoided, and the availability of the unmanned aerial vehicle is greatly expanded.

In some optional embodiments, referring to FIG. 6, FIG. 6 is a flowchart of an information transmission method shown according to an embodiment. The method may be performed by a first unmanned aerial vehicle. Herein, the first unmanned aerial vehicle may be a 5G unmanned aerial vehicle that has just performed cell reselection. The method may include the following steps 601-602.

At step 601, in response to determining that cell reselection has been performed, a base station to be accessed after the cell reselection is determined.

In an embodiment of the present disclosure, the first unmanned aerial vehicle may be in an idle state or an inactive state. The first unmanned aerial vehicle performs cell reselection during flight, and determines a base station to be accessed after the cell reselection.

At step 602, upon completion of a target operation, flight path information of the first unmanned aerial vehicle is reported to the base station with first medium access control (MAC) signaling.

In the embodiment of the present disclosure, the first MAC signaling may be MAC layer signaling newly defined in the protocol. The first MAC signaling is for reporting the flight path information.

In a possible implementation, the first MAC signaling may be defined as flight path report MAC control element (CE) signaling.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle. In the embodiment, after the first unmanned aerial vehicle performs the cell reselection to determine the base station to be accessed, and completes the target operation, the first unmanned aerial vehicle may report the flight path information of the first unmanned aerial vehicle to the base station with the first MAC signaling. The possibility of the mutual collision between the unmanned aerial vehicles during the flight is reduced, the economic loss is avoided, and the availability of the unmanned aerial vehicle is greatly expanded.

The information transmission method provided in the present disclosure is described again from a side of a base station below.

An embodiment of the present disclosure provides an information transmission method. Referring to FIG. 7, FIG. 7 is a flowchart of an information transmission method shown according to an embodiment. The method may be performed by a base station. The method may include the following steps 701-702.

At step 701, flight path information of a first unmanned aerial vehicle reported by the first unmanned aerial vehicle is received.

In the embodiment of the present disclosure, the first unmanned aerial vehicle is a 5G unmanned aerial vehicle that is to access the base station after performing cell reselection.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

At step 702, the flight path information of the first unmanned aerial vehicle is sent to a second unmanned aerial vehicle.

In the embodiment of the present disclosure, the second unmanned aerial vehicle is a 5G unmanned aerial vehicle that has accessed the base station.

In the embodiment, after the base station receives the flight path information of the first unmanned aerial vehicle, the base station may send the flight path information to the second unmanned aerial vehicle, which reduces the possibility of the mutual collision between the unmanned aerial vehicles during the flight, avoids the economic loss, and greatly extends the availability of the unmanned aerial vehicle.

In some optional embodiments, referring to FIG. 8, FIG. 8 is a flowchart of an information transmission method shown according to an embodiment. The method may be performed by a base station. The method may include the following steps 801-802.

At step 801, the flight path information of the first unmanned aerial vehicle reported by the first unmanned aerial vehicle in a process of establishing an RRC connection with the base station is received.

In the embodiment of the present disclosure, the first unmanned aerial vehicle is a 5G unmanned aerial vehicle that is to access the base station after performing cell reselection.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

At step 802, the flight path information of the first unmanned aerial vehicle is sent to a second unmanned aerial vehicle.

In the embodiment of the present disclosure, the second unmanned aerial vehicle is a 5G unmanned aerial vehicle that has accessed the base station.

In the embodiment, the base station may receive the flight path information of the first unmanned aerial vehicle reported by the first unmanned aerial vehicle in the process of establishing the RRC connection with the base station, and then send the flight path information to the second unmanned aerial vehicle, which reduces the possibility of the mutual collision between the unmanned aerial vehicles during the flight, avoids the economic loss, and greatly extends the availability of the unmanned aerial vehicle.

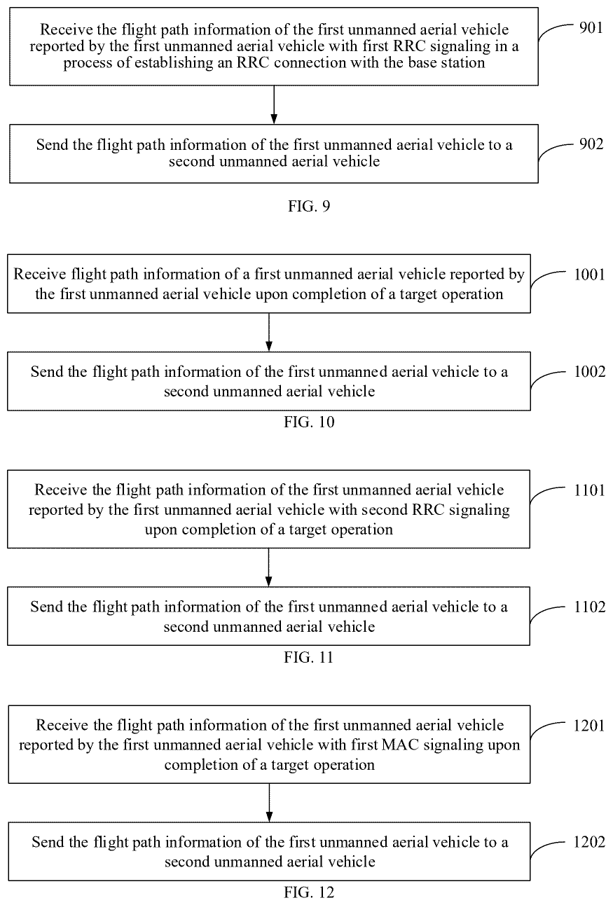

In some optional embodiments, referring to FIG. 9, FIG. 9 is a flowchart of an information transmission method shown according to an embodiment. The method may be performed by a base station. The method may include the following steps 901-902.

At step 901, the flight path information of the first unmanned aerial vehicle reported by the first unmanned aerial vehicle with first RRC signaling in a process of establishing an RRC connection with the base station is received.

In the embodiment of the present disclosure, the first unmanned aerial vehicle is a 5G unmanned aerial vehicle that is to access the base station after performing cell reselection. The first RRC signaling may multiplex existing RRC signaling in a protocol, or may be RRC signaling newly defined in the protocol, which is not limited in the present disclosure.

In a possible implementation, in the case where the first RRC signaling multiplexes the existing RRC signaling in the protocol, the first RRC signaling may multiplex RRC signaling related to the random access process.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

At step 902, the flight path information of the first unmanned aerial vehicle is sent to a second unmanned aerial vehicle.

In the embodiment of the present disclosure, the second unmanned aerial vehicle is a 5G unmanned aerial vehicle that has accessed the base station.

In the embodiment, the base station may receive the flight path information of the first unmanned aerial vehicle reported by the first unmanned aerial vehicle with the first RRC signaling in the process of establishing the RRC connection with the base station, and then send the flight path information to the second unmanned aerial vehicle, which reduces the possibility of the mutual collision between the unmanned aerial vehicles during the flight, avoids the economic loss, and greatly extends the availability of the unmanned aerial vehicle.

In some optional embodiments, the first RRC signaling may be to carry a target message for a random access process.

In a possible implementation, the target message may be a message 3. The message 3 may be a related request message that is sent by the first unmanned aerial vehicle serving as the user equipment to the base station in the random access process and is for initiating the random access process.

Correspondingly, the first RRC signaling may be any one of: RRC reestablishment request signaling, RRC resume request signaling, or RRC setup request signaling.

In another possible implementation, the target message is a message 5. The message 5 may be sent by the first unmanned aerial vehicle serving as the user equipment to the base station in the random access process and be for notifying the base station that the random access process is completed.

Correspondingly, the first RRC signaling is any one of: RRC reconfiguration complete signaling, RRC reestablishment complete signaling, RRC resume complete signaling, or RRC setup complete signaling.

In some optional embodiments, referring to FIG. 10, FIG. 10 is a flowchart of an information transmission method shown according to an embodiment. The method may be performed by a base station. The method may include the following steps 1001-1002.

At step 1001, flight path information of a first unmanned aerial vehicle reported by the first unmanned aerial vehicle upon completion of a target operation is received.

In the embodiment of the present disclosure, the first unmanned aerial vehicle is a 5G unmanned aerial vehicle that is to access the base station after performing cell reselection.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

In the embodiment of the present disclosure, the target operation is an operation associated with an RRC connection between the first unmanned aerial vehicle and the base station.

In a possible implementation, the target operation includes any one of: an RRC connection establishment operation, an RRC connection reestablishment operation, an RRC restart operation, or an RRC reconfiguration operation.

At step 1002, the flight path information of the first unmanned aerial vehicle is sent to a second unmanned aerial vehicle.

In the embodiment of the present disclosure, the second unmanned aerial vehicle is a 5G unmanned aerial vehicle that has accessed the base station.

In the embodiment, the base station may receive the flight path information of the first unmanned aerial vehicle reported by the first unmanned aerial vehicle upon the completion of the target operation, and then send the flight path information to the second unmanned aerial vehicle, which reduces the possibility of the mutual collision between the unmanned aerial vehicles during the flight, avoids the economic loss, and greatly extends the availability of the unmanned aerial vehicle.

In some optional embodiments, referring to FIG. 11, FIG. 11 is a flowchart of an information transmission method shown according to an embodiment. The method may be performed by a base station. The method may include the following steps 1101-1102.

At step 1101, the flight path information of the first unmanned aerial vehicle reported by the first unmanned aerial vehicle with second RRC signaling upon completion of a target operation is received.

In the embodiment of the present disclosure, the first unmanned aerial vehicle is a 5G unmanned aerial vehicle that is to access the base station after performing cell reselection.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

In the embodiment of the present disclosure, the target operation is an operation associated with an RRC connection between the first unmanned aerial vehicle and the base station.

In a possible implementation, the target operation includes any one of: an RRC connection establishment operation, an RRC connection reestablishment operation, an RRC restart operation, or an RRC reconfiguration operation.

The second RRC signaling may multiplex existing RRC signaling in the protocol, or may be RRC signaling newly defined in the protocol, which is not limited in the present disclosure.

In a possible implementation, in the case where the second RRC signaling multiplexes the existing RRC signaling in the protocol, the second RRC signaling may be specifically UE assistance information signaling.

At step 1102, the flight path information of the first unmanned aerial vehicle is sent to a second unmanned aerial vehicle.

In the embodiment of the present disclosure, the second unmanned aerial vehicle is a 5G unmanned aerial vehicle that has accessed the base station.

In the embodiment, the base station may receive the flight path information of the first unmanned aerial vehicle reported by the first unmanned aerial vehicle with the second RRC signaling upon the completion of the target operation, and then send the flight path information to the second unmanned aerial vehicle, which reduces the possibility of the mutual collision between the unmanned aerial vehicles during the flight, avoids the economic loss, and greatly extends the availability of the unmanned aerial vehicle.

In some optional embodiments, referring to FIG. 12, FIG. 12 is a flowchart of an information transmission method shown according to an embodiment. The method may be performed by a base station. The method may include the following steps 1201-1202.

At step 1201, the flight path information of the first unmanned aerial vehicle reported by the first unmanned aerial vehicle with first MAC signaling upon completion of a target operation is received.

In the embodiment of the present disclosure, the first unmanned aerial vehicle is a 5G unmanned aerial vehicle that is to access the base station after performing cell reselection.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

In the embodiment of the present disclosure, the target operation is an operation associated with an RRC connection between the first unmanned aerial vehicle and the base station.

In a possible implementation, the target operation includes any one of: an RRC connection establishment operation, an RRC connection reestablishment operation, an RRC restart operation, or an RRC reconfiguration operation.

In the embodiment of the present disclosure, the first MAC signaling may be MAC layer signaling newly defined in the protocol. The first MAC signaling is for reporting the flight path information.

In a possible implementation, the first MAC signaling may be defined as flight path report MAC control element (CE) signaling.

At step 1202, the flight path information of the first unmanned aerial vehicle is sent to a second unmanned aerial vehicle.

In the embodiment of the present disclosure, the second unmanned aerial vehicle is a 5G unmanned aerial vehicle that has accessed the base station.

In the embodiment, the base station may receive the flight path information of the first unmanned aerial vehicle reported by the first unmanned aerial vehicle with the first MAC signaling upon the completion of the target operation, and then send the flight path information to the second unmanned aerial vehicle, which reduces the possibility of the mutual collision between the unmanned aerial vehicles during the flight, avoids the economic loss, and greatly extends the availability of the unmanned aerial vehicle.

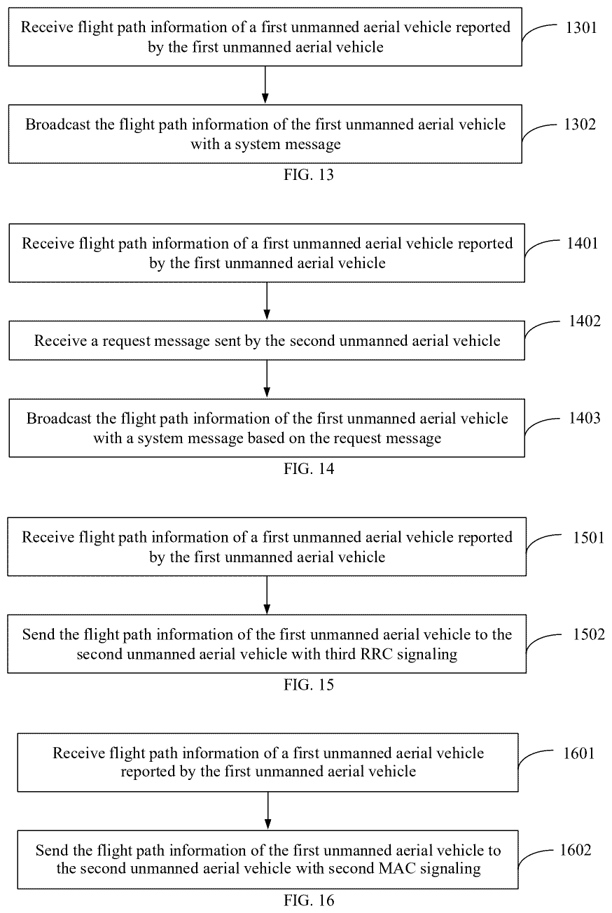

In some optional embodiments, referring to FIG. 13, FIG. 13 is a flowchart of an information transmission method shown according to an embodiment. The method may be performed by a base station. The method may include the following steps 1301-1302.

At step 1301, flight path information of a first unmanned aerial vehicle reported by the first unmanned aerial vehicle is received.

In the embodiment of the present disclosure, the first unmanned aerial vehicle is a 5G unmanned aerial vehicle that is to access the base station after performing cell reselection.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

At step 1302, the flight path information of the first unmanned aerial vehicle with a system message is broadcast.

In the embodiment of the present disclosure, the base station may add the flight path information of the first unmanned aerial vehicle in the system message, so that the second unmanned aerial vehicle may obtain the flight path information of the first unmanned aerial vehicle by reading the system message. The second unmanned aerial vehicle is a 5G unmanned aerial vehicle that has accessed the base station.

In a possible implementation, the system message is a system information block (SIB). The SIB may multiplex an existing SIB1 in the protocol, or may be an SIB newly defined in the protocol, which is not limited in the present disclosure. The SIB belongs to other system information (other SI).

In another possible implementation, the system message may also be a master information block (MIB).

In the embodiment, the base station may send the flight path information of the first unmanned aerial vehicle to the second unmanned aerial vehicle with the system message, which reduces the possibility of the mutual collision between the unmanned aerial vehicles during the flight, avoids the economic loss, and greatly extends the availability of the unmanned aerial vehicle.

In some optional embodiments, referring to FIG. 14, FIG. 14 is a flowchart of an information transmission method shown according to an embodiment. The method may be performed by a base station. The method may include the following steps 1401-1403.

At step 1401, flight path information of a first unmanned aerial vehicle reported by the first unmanned aerial vehicle is received.

In the embodiment of the present disclosure, the first unmanned aerial vehicle is a 5G unmanned aerial vehicle that is to access the base station after performing cell reselection.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

At step 1402, a request message sent by the second unmanned aerial vehicle is received.

In an embodiment of the present disclosure, the request message is for requesting to obtain the flight path information of the first unmanned aerial vehicle. The second unmanned aerial vehicle is a 5G unmanned aerial vehicle that has accessed the base station.

At step 1403, the flight path information of the first unmanned aerial vehicle is broadcast with a system message based on the request message.

In the embodiment of the present disclosure, the base station may add the flight path information of the first unmanned aerial vehicle in the system message, so that the second unmanned aerial vehicle may obtain the flight path information of the first unmanned aerial vehicle by reading the system message.

In a possible implementation, the system message is an SIB. The SIB may multiplex an existing SIB1 in the protocol, or may be an SIB newly defined in the protocol, which is not limited in the present disclosure. The SIB belongs to other SI.

In another possible implementation, the system message may also be an MIB.

In the embodiment, the base station may send the flight path information of the first unmanned aerial vehicle to the second unmanned aerial vehicle with the system message after receiving the request message sent by the second unmanned aerial vehicle, which reduces the possibility of the mutual collision between the unmanned aerial vehicles during the flight, avoids the economic loss, and greatly extends the availability of the unmanned aerial vehicle.

In some optional embodiments, referring to FIG. 15, FIG. 15 is a flowchart of an information transmission method shown according to an embodiment. The method may be performed by a base station. The method may include the following steps 1501-1502.

At step 1501, flight path information of a first unmanned aerial vehicle reported by the first unmanned aerial vehicle is received.

In the embodiment of the present disclosure, the first unmanned aerial vehicle is a 5G unmanned aerial vehicle that is to access the base station after performing cell reselection.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

At step 1502, the flight path information of the first unmanned aerial vehicle is sent to the second unmanned aerial vehicle with third RRC signaling.

In the embodiment of the present disclosure, the third RRC signaling may multiplex existing RRC signaling in a protocol, or may be RRC signaling newly defined in the protocol, which is not limited in the present disclosure. The base station may send the flight path information of the first unmanned aerial vehicle to the second unmanned aerial vehicle with unicast third RRC signaling. The second unmanned aerial vehicle is a 5G unmanned aerial vehicle that has accessed the base station.

In a possible implementation, in the case where the third RRC signaling multiplexes the existing RRC signaling in the protocol, the third RRC signaling may be specifically RRC reconfiguration signaling.

In the embodiment, the base station may send the flight path information of the first unmanned aerial vehicle to the second unmanned aerial vehicle with the unicast third RRC signaling. The possibility of the mutual collision between the unmanned aerial vehicles during the flight is reduced, the economic loss is avoided, and the availability of the unmanned aerial vehicle is greatly expanded.

In some optional embodiments, referring to FIG. 16, FIG. 16 is a flowchart of an information transmission method shown according to an embodiment. The method may be performed by a base station. The method may include the following steps 1601-1602.

At step 1601, flight path information of a first unmanned aerial vehicle reported by the first unmanned aerial vehicle is received.

In the embodiment of the present disclosure, the first unmanned aerial vehicle is a 5G unmanned aerial vehicle that is to access the base station after performing cell reselection.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

At step 1602, the flight path information of the first unmanned aerial vehicle is sent to the second unmanned aerial vehicle with second MAC signaling.

In the embodiment of the present disclosure, the second MAC signaling may be MAC layer signaling newly defined in the protocol. The second MAC signaling is for indicating the flight path information. The second unmanned aerial vehicle is a 5G unmanned aerial vehicle that has accessed the base station.

In a possible implementation, the second MAC signaling may be defined as flight path information MAC CE signaling.

In the embodiment, the base station may send the flight path information of the first unmanned aerial vehicle to the second unmanned aerial vehicle with the second MAC signaling. The possibility of the mutual collision between the unmanned aerial vehicles during the flight is reduced, the economic loss is avoided, and the availability of the unmanned aerial vehicle is greatly expanded.

The information transmission method provided in the present disclosure is described again from a side of a second unmanned aerial vehicle below.

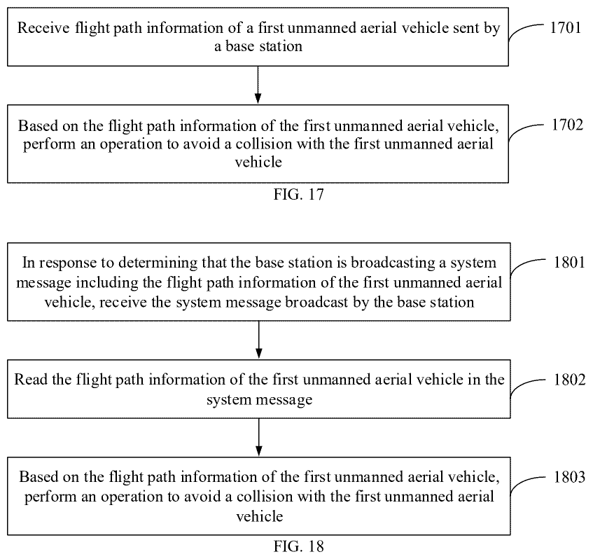

An embodiment of the present disclosure provides an information transmission method. Referring to FIG. 17, FIG. 17 is a flowchart of an information transmission method shown according to an embodiment. The method may be performed by a second unmanned aerial vehicle. Herein, the second unmanned aerial vehicle is a 5G unmanned aerial vehicle that has accessed a base station. The method may include the following steps 1701-1702.

At step 1701, flight path information of a first unmanned aerial vehicle sent by a base station is received.

In the embodiment of the present disclosure, the first unmanned aerial vehicle is a 5G unmanned aerial vehicle that is to access the base station after performing cell reselection.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

At step 1702, based on the flight path information of the first unmanned aerial vehicle, an operation to avoid a collision with the first unmanned aerial vehicle is performed.

In the embodiment of the present disclosure, the operation to avoid the collision with the first unmanned aerial vehicle may include that: a flight position of the first unmanned aerial vehicle at each of specified time points is determined according to the flight path information of the first unmanned aerial vehicle; and when the second unmanned aerial vehicle at a same time point is also at a same flight position as the first unmanned aerial vehicle, or near the flight position with a distance from the second unmanned aerial vehicle to the first unmanned aerial vehicle within a preset range, the second unmanned aerial vehicle may adjust a flight path of the second unmanned aerial vehicle, thereby avoiding the collision with the first unmanned aerial vehicle.

In the embodiment, after the second unmanned aerial vehicle receives the flight path information of the first unmanned aerial vehicle, the second unmanned aerial vehicle may perform the operation to avoid the collision with the first unmanned aerial vehicle. The possibility of the mutual collision between the unmanned aerial vehicles during the flight is reduced, the economic loss is avoided, and the availability of the unmanned aerial vehicle is greatly expanded.

In some optional embodiments, referring to FIG. 18, FIG. 18 is a flowchart of an information transmission method shown according to an embodiment. The method may be performed by a second unmanned aerial vehicle. Herein, the second unmanned aerial vehicle is a 5G unmanned aerial vehicle that has accessed a base station. The method may include the following steps 1801-1803.

At step 1801, in response to determining that the base station is broadcasting a system message including the flight path information of the first unmanned aerial vehicle, the system message broadcast by the base station is received.

In the embodiment of the present disclosure, the first unmanned aerial vehicle is a 5G unmanned aerial vehicle that is to access the base station after performing cell reselection.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

In a possible implementation, the system message is an SIB. The SIB may multiplex an existing SIB1 in the protocol, or may be an SIB newly defined in the protocol, which is not limited in the present disclosure. The SIB belongs to other SI.

In another possible implementation, the system message may also be an MIB.

At step 1802, the flight path information of the first unmanned aerial vehicle in the system message is read.

At step 1803, based on the flight path information of the first unmanned aerial vehicle, an operation to avoid a collision with the first unmanned aerial vehicle is performed.

In the embodiment of the present disclosure, the operation to avoid the collision with the first unmanned aerial vehicle includes that: a flight position of the first unmanned aerial vehicle at each of specified time points is determined according to the flight path information of the first unmanned aerial vehicle; and when the second unmanned aerial vehicle at a same time point is also at a same flight position as the first unmanned aerial vehicle, or near the flight position with a distance from the second unmanned aerial vehicle to the first unmanned aerial vehicle within a preset range, the second unmanned aerial vehicle may adjust a flight path of the second unmanned aerial vehicle, thereby avoiding the collision with the first unmanned aerial vehicle.

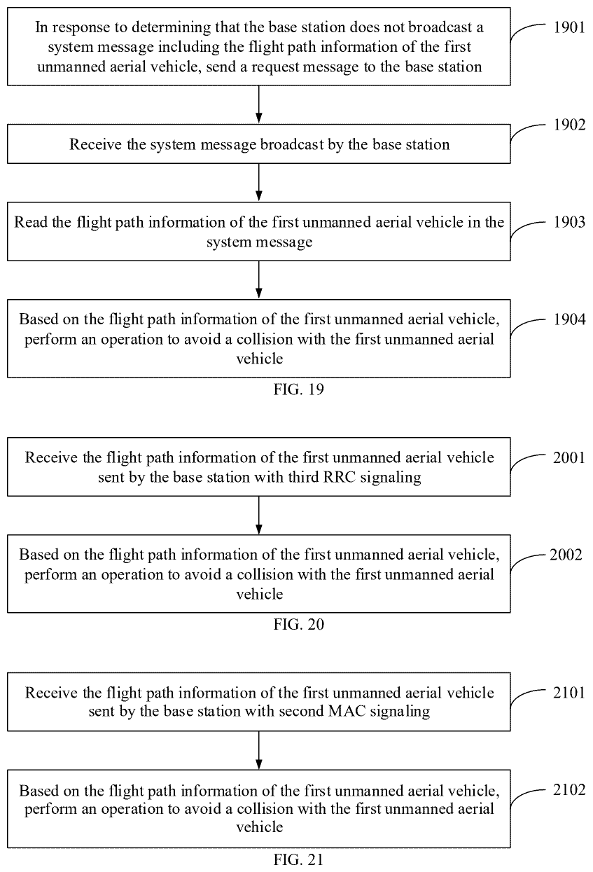

In the embodiment, after the second unmanned aerial vehicle obtains the flight path information of the first unmanned aerial vehicle with the system message broadcast by the base station, the second unmanned aerial vehicle may perform the operation to avoid the collision with the first unmanned aerial vehicle. The possibility of the mutual collision between the unmanned aerial vehicles during the flight is reduced, the economic loss is avoided, and the availability of the unmanned aerial vehicle is greatly expanded. In some optional embodiments, referring to FIG. 19, FIG. 19 is a flowchart of an information transmission method shown according to an embodiment. The method may be performed by a second unmanned aerial vehicle. Herein, the second unmanned aerial vehicle is a 5G unmanned aerial vehicle that has accessed a base station. The method may include the following steps 1901-1904.

At step 1901, in response to determining that the base station does not broadcast a system message including the flight path information of the first unmanned aerial vehicle, a request message is sent to the base station.

In the embodiment of the present disclosure, the first unmanned aerial vehicle is a 5G unmanned aerial vehicle that is to access the base station after performing cell reselection.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

In a possible implementation, the system message is an SIB. The SIB may multiplex an existing SIB1 in the protocol, or may be an SIB newly defined in the protocol, which is not limited in the present disclosure. The SIB belongs to other SI.

In another possible implementation, the system message may also be an MIB.

In an embodiment of the present disclosure, the request message is for requesting to obtain the flight path information of the first unmanned aerial vehicle.

At step 1902, the system message broadcast by the base station is received.

At step 1903, the flight path information of the first unmanned aerial vehicle in the system message is read.

At step 1904, based on the flight path information of the first unmanned aerial vehicle, an operation to avoid a collision with the first unmanned aerial vehicle is performed.

In the embodiment of the present disclosure, the operation to avoid the collision with the first unmanned aerial vehicle includes that: a flight position of the first unmanned aerial vehicle at each of specified time points is determined according to the flight path information of the first unmanned aerial vehicle; and when the second unmanned aerial vehicle at a same time point is also at a same flight position as the first unmanned aerial vehicle, or near the flight position with a distance from the second unmanned aerial vehicle to the first unmanned aerial vehicle within a preset range, the second unmanned aerial vehicle may adjust a flight path of the second unmanned aerial vehicle, thereby avoiding the collision with the first unmanned aerial vehicle. In the embodiment, the second unmanned aerial vehicle may firstly send the request message, then receive the system message broadcast by the base station, and may perform the operation to avoid the collision with the first unmanned aerial vehicle, after obtaining the flight path information of the first unmanned aerial vehicle. The possibility of the mutual collision between the unmanned aerial vehicles during the flight is reduced, the economic loss is avoided, and the availability of the unmanned aerial vehicle is greatly expanded.

In some optional embodiments, referring to FIG. 20, FIG. 20 is a flowchart of an information transmission method shown according to an embodiment. The method may be performed by a second unmanned aerial vehicle. Herein, the second unmanned aerial vehicle is a 5G unmanned aerial vehicle that has accessed a base station. The method may include the following steps 2001-2002.

At step 2001, the flight path information of the first unmanned aerial vehicle sent by the base station with third RRC signaling is received.

In the embodiment of the present disclosure, the first unmanned aerial vehicle is a 5G unmanned aerial vehicle that is to access the base station after performing cell reselection.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

In the embodiment of the present disclosure, the third RRC signaling may multiplex existing RRC signaling in a protocol, or may be RRC signaling newly defined in the protocol, which is not limited in the present disclosure.

In a possible implementation, in the case where the third RRC signaling multiplexes the existing RRC signaling in the protocol, the third RRC signaling may be specifically RRC reconfiguration signaling.

At step 2002, based on the flight path information of the first unmanned aerial vehicle, an operation to avoid a collision with the first unmanned aerial vehicle is performed.

In the embodiment of the present disclosure, the operation to avoid the collision with the first unmanned aerial vehicle includes that: a flight position of the first unmanned aerial vehicle at each of specified time points is determined according to the flight path information of the first unmanned aerial vehicle; and when the second unmanned aerial vehicle at a same time point is also at a same flight position as the first unmanned aerial vehicle, or near the flight position with a distance from the second unmanned aerial vehicle to the first unmanned aerial vehicle within a preset range, the second unmanned aerial vehicle may adjust a flight path of the second unmanned aerial vehicle, thereby avoiding the collision with the first unmanned aerial vehicle.

In the embodiment, after the second unmanned aerial vehicle obtains the flight path information of the first unmanned aerial vehicle with third RRC signaling unicast by the base station, the second unmanned aerial vehicle may perform the operation to avoid the collision with the first unmanned aerial vehicle. The possibility of the mutual collision between the unmanned aerial vehicles during the flight is reduced, the economic loss is avoided, and the availability of the unmanned aerial vehicle is greatly expanded.

In some optional embodiments, referring to FIG. 21, FIG. 21 is a flowchart of an information transmission method shown according to an embodiment. The method may be performed by a second unmanned aerial vehicle. Herein, the second unmanned aerial vehicle is a 5G unmanned aerial vehicle that has accessed a base station. The method may include the following steps 2101-2102.

At step 2101, the flight path information of the first unmanned aerial vehicle sent by the base station with second MAC signaling is received.

In the embodiment of the present disclosure, the first unmanned aerial vehicle is a 5G unmanned aerial vehicle that is to access the base station after performing cell reselection.

In a possible implementation, the flight path information includes but is not limited to at least one of: a flight direction, a flight speed, a flight point location, a flight height, or a flight angle.

As an example, the flight direction may be a direction in which the unmanned aerial vehicle flies currently relative to the base station, or may be a direction in which the unmanned aerial vehicle flies currently relative to a specified reference point or another unmanned aerial vehicle. The flight speed may be a speed at which the unmanned aerial vehicle flies currently relative to the base station, or may be a speed at which the unmanned aerial vehicle flies currently relative to another unmanned aerial vehicle or a specified reference point. The flight point location may be a global positioning system (GPS) coordinate. The flight height may be an absolute height of the unmanned aerial vehicle relative to a sea level, or may be a relative height of the unmanned aerial vehicle relative to the base station or a specified reference point. The flight angle may be an angle of the unmanned aerial vehicle relative to the base station or a specified reference point, such as a pitch angle, a yaw angle, and a roll angle.

In the embodiment of the present disclosure, the second MAC signaling may be MAC layer signaling newly defined in the protocol. The second MAC signaling is for indicating the flight path information.

In a possible implementation, the second MAC signaling may be defined as flight path information MAC CE signaling.

At step 2102, based on the flight path information of the first unmanned aerial vehicle, an operation to avoid a collision with the first unmanned aerial vehicle is performed.

In the embodiment of the present disclosure, the operation to avoid the collision with the first unmanned aerial vehicle includes that: a flight position of the first unmanned aerial vehicle at each of specified time points is determined according to the flight path information of the first unmanned aerial vehicle; and when the second unmanned aerial vehicle at a same time point is also at a same flight position as the first unmanned aerial vehicle, or near the flight position with a distance from the second unmanned aerial vehicle to the first unmanned aerial vehicle within a preset range, the second unmanned aerial vehicle may adjust a flight path of the second unmanned aerial vehicle, thereby avoiding the collision with the first unmanned aerial vehicle.

In the embodiment, after the second unmanned aerial vehicle obtains the flight path information of the first unmanned aerial vehicle with the second MAC signaling sent by the base station, the second unmanned aerial vehicle may perform the operation to avoid the collision with the first unmanned aerial vehicle. The possibility of the mutual collision between the unmanned aerial vehicles during the flight is reduced, the economic loss is avoided, and the availability of the unmanned aerial vehicle is greatly expanded.

Corresponding to the embodiments of information transmission methods, the present disclosure further provides embodiments of information transmission apparatuses.

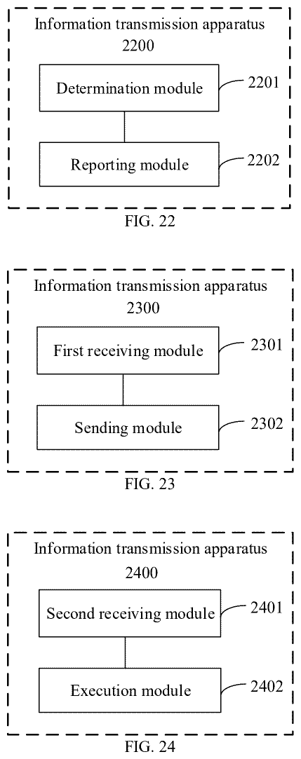

Referring to FIG. 22, FIG. 22 is a block diagram of an information transmission apparatus 2200 shown according to an exemplary embodiment. The apparatus 2200 is applied to a first unmanned aerial vehicle and includes: a determination module 2201 and a reporting module 2202.

The determination module 2201 is configured to determine, in response to determining that cell reselection has been performed, a base station to be accessed after the cell reselection.

The reporting module 2202is configured to report flight path information of the first unmanned aerial vehicle to the base station.

Referring to FIG. 23, FIG. 23 is a block diagram of an information transmission apparatus 2300 shown according to an exemplary embodiment. The apparatus 2300 is applied to a base station and includes a first receiving module 2301 and a sending module 2302.

The first receiving module 2301 is configured to receive flight path information of a first unmanned aerial vehicle reported by the first unmanned aerial vehicle; where the first unmanned aerial vehicle is an unmanned aerial vehicle that is to access the base station after performing cell reselection.

The sending module 2302 is configured to send the flight path information of the first unmanned aerial vehicle to a second unmanned aerial vehicle; where the second unmanned aerial vehicle is an unmanned aerial vehicle that has accessed the base station.

Referring to FIG. 24, FIG. 24 is a block diagram of an information transmission apparatus 2400 shown according to an exemplary embodiment. The apparatus 2400 is applied to a second unmanned aerial vehicle and includes a second receiving module 2401 and an execution module 2402.

The second receiving module 2401 is configured to receive flight path information of a first unmanned aerial vehicle sent by a base station; where the first unmanned aerial vehicle is an unmanned aerial vehicle that is to access the base station after performing cell reselection.

The execution module 2402 is configured to perform, based on the flight path information of the first unmanned aerial vehicle, an operation to avoid a collision with the first unmanned aerial vehicle.

Since the embodiments of the apparatuses substantially corresponds to the embodiments of the methods, and the related contents can refer to the description of the embodiments of the methods. The embodiments of the apparatuses described are only schematic. The units explained as separate components may be or may not be physically separated, and the components displayed as units may be or may not be physical units, that is, they may be located in one place or may be distributed across multiple network units. A part or all of modules may be selected according to actual needs to achieve the purpose of the solutions in the present disclosure. Those skilled in the art may understand and implement other embodiments without a creative work.

Correspondingly, the present disclosure further provides a non-transitory computer readable storage medium. The non-transitory computer readable storage medium stores a computer program, and the computer program is configured to perform any one information transmission method for the side of the first unmanned aerial vehicle.

Correspondingly, the present disclosure further provides a non-transitory computer readable storage medium. The non-transitory computer readable storage medium stores a computer program, and the computer program is configured to perform any one information transmission method for the side of the base station.

Correspondingly, the present disclosure further provides a non-transitory computer readable storage medium. The non-transitory computer readable storage medium stores a computer program, and the computer program is configured to perform any one information transmission method for the side of the second unmanned aerial vehicle.

Correspondingly, the present disclosure further provides an information transmission apparatus, including a processor; and a memory configured to store instructions executable by the processor. Where the processor is configured to perform any one information transmission method for the side of the first unmanned aerial vehicle.

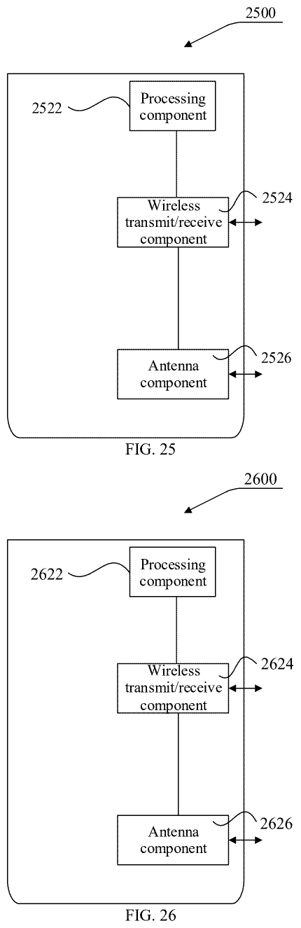

As shown in FIG. 25, FIG. 25 is a schematic structural diagram of an information transmission apparatus 2500 shown according to an exemplary embodiment. The apparatus 2500 may be provided as the first unmanned aerial vehicle. Referring to FIG. 25, the apparatus 2500 includes a processing component 2522, a wireless transmit/receive component 2524, an antenna component 2526, and a signal processing part specific to a wireless interface (not shown). The processing component 2522 may further include at least one processor (not shown).

One processor of the processing component 2522 may be configured to perform any one information transmission method for the side of the first unmanned aerial vehicle.

Correspondingly, the present disclosure further provides an information transmission apparatus, including a processor; and a memory configured to store instructions executable by the processor. Where the processor is configured to perform any one information transmission method for the side of the base station.

As shown in FIG. 26, FIG. 26 is a schematic structural diagram of an information transmission apparatus 2600 shown according to an exemplary embodiment. The apparatus 2600 may be provided as the base station. Referring to FIG. 26, the apparatus 2600 includes a processing component 2622, a wireless transmit/receive component 2624, an antenna component 2626, and a signal processing part specific to a wireless interface (not shown). The processing component 2622 may further include at least one processor (not shown).

One processor of the processing component 2622 may be configured to perform any one information transmission method for the side of the base station.

Correspondingly, the present disclosure further provides an information transmission apparatus, including a processor; and a memory configured to store instructions executable by the processor. Where the processor is configured to perform any one information transmission method for the side of the second unmanned aerial vehicle.

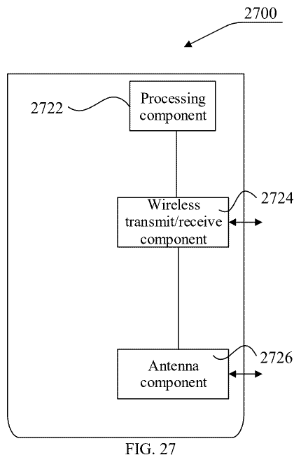

As shown in FIG. 27, FIG. 27 is a schematic structural diagram of an information transmission apparatus 2700 shown according to an exemplary embodiment. The apparatus 2700 may be provided as the second unmanned aerial vehicle. Referring to FIG. 27, the apparatus 2700 includes a processing component 2722, a wireless transmit/receive component 2724, an antenna component 2726, and a signal processing part specific to a wireless interface (not shown). The processing component 2722 may further include at least one processor (not shown).

One processor of the processing component 2722 may be configured to perform any one information transmission method for the side of the second unmanned aerial vehicle.

Those skilled in the art will easily come up with other implementation solutions of the present disclosure after considering the specification and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure. The specification and embodiments are only considered exemplary, and the true scope and spirit of the present disclosure are indicated by the following claims. claims.

It should be understood that the present disclosure is not limited to the precise structure described and shown in the accompanying drawings, and various modifications and changes may be made without departing from its scope. The scope of the present disclosure is limited only by the appended claims.

Optionally, reporting flight path information of the first unmanned aerial vehicle to the base station, includes: reporting, in a process of establishing a radio resource control (RRC) connection with the base station, the flight path information of the first unmanned aerial vehicle to the base station.

Optionally, reporting, in a process of establishing a radio resource control (RRC) connection with the base station, the flight path information of the first unmanned aerial vehicle to the base station, includes: reporting, in the process of establishing the RRC connection with the base station, the flight path information of the first unmanned aerial vehicle to the base station with first RRC signaling.

Optionally, the first RRC signaling is to carry a target message for a random access process.

Optionally, the target message is a message 3, and the first RRC signaling is any one of: RRC reestablishment request signaling, RRC resume request signaling, or RRC setup request signaling.

Optionally, the target message is a message 5, and the first RRC signaling is any one of: RRC reconfiguration complete signaling, RRC reestablishment complete signaling, RRC resume complete signaling, or RRC setup complete signaling.

Optionally, reporting flight path information of the first unmanned aerial vehicle to the base station, includes: reporting, upon completion of a target operation, the flight path information of the first unmanned aerial vehicle to the base station; where the target operation is an operation associated with an RRC connection between the first unmanned aerial vehicle and the base station.

Optionally, the target operation includes any one of: an RRC connection establishment operation, an RRC connection reestablishment operation, an RRC restart operation, or an RRC reconfiguration operation.

Optionally, reporting, upon completion of a target operation, the flight path information of the first unmanned aerial vehicle to the base station, includes: reporting, upon the completion of the target operation, the flight path information of the first unmanned aerial vehicle to the base station with second RRC signaling.

Optionally, the second RRC signaling is UE assistance information signaling.

Optionally, reporting, upon completion of a target operation, the flight path information of the first unmanned aerial vehicle to the base station, includes: reporting, upon the completion of the target operation, the flight path information of the first unmanned aerial vehicle to the base station with first medium access control (MAC) signaling; where the first MAC signaling is for reporting the flight path information.

Optionally, the flight path information includes at least one of: a flight direction, a flight speed, a flight point location, a flight height, or a flight angle.

Optionally, receiving flight path information of a first unmanned aerial vehicle reported by the first unmanned aerial vehicle, includes: receiving the flight path information of the first unmanned aerial vehicle reported by the first unmanned aerial vehicle in a process of establishing a radio resource control (RRC) connection with the base station.

Optionally, receiving the flight path information of the first unmanned aerial vehicle reported by the first unmanned aerial vehicle in a process of establishing the RRC connection with the base station, includes: receiving the flight path information of the first unmanned aerial vehicle reported by the first unmanned aerial vehicle with first RRC signaling in the process of establishing the RRC connection with the base station.

Optionally, the first RRC signaling is to carry a target message for a random access process.

Optionally, the target message is a message 3, and the first RRC signaling is any one of: RRC reestablishment request signaling, RRC resume request signaling, or RRC setup request signaling.

Optionally, the target message is a message 5, and the first RRC signaling is any one of: RRC reconfiguration complete signaling, RRC reestablishment complete signaling, RRC resume complete signaling, or RRC setup complete signaling.

Optionally, receiving flight path information of a first unmanned aerial vehicle reported by the first unmanned aerial vehicle, includes: receiving the flight path information of the first unmanned aerial vehicle reported by the first unmanned aerial vehicle upon completion of a target operation; where the target operation is an operation associated with an RRC connection between the first unmanned aerial vehicle and the base station.

Optionally, the target operation includes any one of: an RRC connection establishment operation, an RRC connection reestablishment operation, an RRC restart operation, or an RRC reconfiguration operation.

Optionally, receiving the flight path information of the first unmanned aerial vehicle reported by the first unmanned aerial vehicle upon completion of a target operation, includes: receiving the flight path information of the first unmanned aerial vehicle reported by the first unmanned aerial vehicle with second RRC signaling upon the completion of the target operation.

Optionally, the second RRC signaling is UE assistance information signaling.

Optionally, receiving the flight path information of the first unmanned aerial vehicle reported by the first unmanned aerial vehicle upon completion of a target operation, includes: receiving the flight path information of the first unmanned aerial vehicle reported by the first unmanned aerial vehicle with first medium access control (MAC) signaling upon the completion of the target operation; where the first MAC signaling is for reporting the flight path information.

Optionally, sending the flight path information of the first unmanned aerial vehicle to a second unmanned aerial vehicle, includes: broadcasting the flight path information of the first unmanned aerial vehicle with a system message.

Optionally, sending the flight path information of the first unmanned aerial vehicle to a second unmanned aerial vehicle, includes: receiving a request message sent by the second unmanned aerial vehicle; where the request message is for requesting to obtain the flight path information of the first unmanned aerial vehicle; and broadcasting, based on the request message, the flight path information of the first unmanned aerial vehicle with a system message.

Optionally, the system message is a system information block (SIB) belonging to other system information (SI).

Optionally, sending the flight path information of the first unmanned aerial vehicle to a second unmanned aerial vehicle, includes: sending the flight path information of the first unmanned aerial vehicle to the second unmanned aerial vehicle with third RRC signaling.

Optionally, the third RRC signaling is RRC reconfiguration signaling.

Optionally, sending the flight path information of the first unmanned aerial vehicle to a second unmanned aerial vehicle, includes: sending the flight path information of the first unmanned aerial vehicle to the second unmanned aerial vehicle with second MAC signaling; where the second MAC signaling is for indicating the flight path information.

Optionally, the flight path information includes at least one of: a flight direction, a flight speed, a flight point location, a flight height, or a flight angle.

Optionally, receiving flight path information of a first unmanned aerial vehicle sent by a base station, includes: receiving, in response to determining that the base station is broadcasting a system message including the flight path information of the first unmanned aerial vehicle, the system message broadcast by the base station; and reading the flight path information of the first unmanned aerial vehicle in the system message.

Optionally, receiving flight path information of a first unmanned aerial vehicle sent by a base station, includes: sending, in response to determining that the base station does not broadcast a system message including the flight path information of the first unmanned aerial vehicle, a request message to the base station; where the request message is for requesting to obtain the flight path information of the first unmanned aerial vehicle; receiving the system message broadcast by the base station; and reading the flight path information of the first unmanned aerial vehicle in the system message.

Optionally, the system message is an SIB belonging to other SI.

Optionally, receiving flight path information of a first unmanned aerial vehicle sent by a base station, includes: receiving the flight path information of the first unmanned aerial vehicle sent by the base station with third RRC signaling.

Optionally, the third RRC signaling is RRC reconfiguration signaling.

Optionally, receiving flight path information of a first unmanned aerial vehicle sent by a base station, includes: receiving the flight path information of the first unmanned aerial vehicle sent by the base station with second MAC signaling; where the second MAC signaling is for indicating the flight path information.

Optionally, the flight path information includes at least one of: a flight direction, a flight speed, a flight point location, a flight height, or a flight angle.

According to a tenth aspect of embodiments of the present disclosure, an information transmission apparatus is provided. The apparatus is applied to a first unmanned aerial vehicle and includes: a determination module, configured to determine, in response to determining that cell reselection has been performed, a base station to be accessed after the cell reselection; and a reporting module, configured to report flight path information of the first unmanned aerial vehicle to the base station.

According to an eleventh aspect of embodiments of the present disclosure, an information transmission apparatus is provided. The apparatus is applied to a base station and includes: a first receiving module, configured to receive flight path information of a first unmanned aerial vehicle reported by the first unmanned aerial vehicle; where the first unmanned aerial vehicle is an unmanned aerial vehicle that is to access the base station after performing cell reselection; and a sending module, configured to send the flight path information of the first unmanned aerial vehicle to a second unmanned aerial vehicle; where the second unmanned aerial vehicle is an unmanned aerial vehicle that has accessed the base station. According to a twelfth aspect of embodiments of the present disclosure, an information transmission apparatus is provided. The apparatus is applied to a second unmanned aerial vehicle and includes: a second receiving module, configured to receive flight path information of a first unmanned aerial vehicle sent by a base station; where the first unmanned aerial vehicle is an unmanned aerial vehicle that is to access the base station after performing cell reselection; and an execution module, configured to perform, based on the flight path information of the first unmanned aerial vehicle, an operation to avoid a collision with the first unmanned aerial vehicle.

According to a twelfth aspect of embodiments of the present disclosure, an information transmission apparatus is provided. The apparatus is applied to a second unmanned aerial vehicle and includes: a second receiving module, configured to receive flight path information of a first unmanned aerial vehicle sent by a base station; where the first unmanned aerial vehicle is an unmanned aerial vehicle that is to access the base station after performing cell reselection; and an execution module, configured to perform, based on the flight path information of the first unmanned aerial vehicle, an operation to avoid a collision with the first unmanned aerial vehicle.

1. An information transmission method, performed by a first unmanned aerial vehicle and comprising:
determining, in response to determining that cell reselection has been performed, a base station to be accessed after the cell reselection; and
reporting flight path information of the first unmanned aerial vehicle to the base station.

2. The method of claim 1, wherein reporting the flight path information of the first unmanned aerial vehicle to the base station, comprises:
reporting, in a process of establishing a radio resource control (RRC) connection with the base station, the flight path information of the first unmanned aerial vehicle to the base station,
wherein first RRC signaling is reported with the flight path information of the first unmanned aerial vehicle to the base station, and
wherein the first RRC signaling is to carry a target message for a random access process.

3-4. (canceled)

5. The method of claim 42, wherein the target message is one of:
a message 3, and the first RRC signaling is any one of:
RRC reestablishment request signaling,
RRC resume request signaling;, or
RRC setup request signaling; or
a message 5, and the first RRC signaling is any one of:
RRC reconfiguration complete signaling.
RRC reestablishment complete signaling,
RRC resume complete signaling, or
RRC setup complete signaling.

6. (canceled)

7. The method of claim 1, wherein reporting the flight path information of the first unmanned aerial vehicle to the base station, comprises:
reporting, upon completion of a target operation, the flight path information of the first unmanned aerial vehicle to the base station; wherein the target operation is an operation associated with an RRC connection between the first unmanned aerial vehicle and the base station;
wherein second RRC signaling is reported with the flight path information of the first unmanned aerial vehicle to the base station; wherein the second RRC signaling is user equipment (UE) assistance information signaling; or
wherein first medium access control (MAC) signaling is reported with the flight path information of the first unmanned aerial vehicle to the base station.

8. The method of claim 7, wherein the target operation comprises any one of:
an RRC connection establishment operation,
an RRC connection reestablishment operation,
an RRC restart operation, or
an RRC reconfiguration operation.

9-11. (canceled)

12. The method of claim 1, wherein the flight path information comprises at least one of:
a flight direction,
a flight speed,
a flight point location,
a flight height, or
a flight angle.

13. An information transmission method, performed by a base station and comprising:
receiving flight path information of a first unmanned aerial vehicle reported by the first unmanned aerial vehicle,
wherein the first unmanned aerial vehicle is an unmanned aerial vehicle that is to access the base station after performing cell reselection; and
sending the flight path information of the first unmanned aerial vehicle to a second unmanned aerial vehicle, and
wherein the second unmanned aerial vehicle is an unmanned aerial vehicle that has accessed the base station.

14. The method of claim 13, wherein receiving the flight path information of the first unmanned aerial vehicle reported by the first unmanned aerial vehicle, comprises:
receiving the flight path information of the first unmanned aerial vehicle reported by the first unmanned aerial vehicle in a process of establishing a radio resource control (RRC) connection with the base station, which comprises:
receiving the flight path information of the first unmanned aerial vehicle reported by the first unmanned aerial vehicle with first RRC signaling in the process of establishing the RRC connection with the base station, and
wherein the first RRC signaling is to carry a target message for a random access process.

15-18. (canceled)

19. The method of claim 13, wherein receiving the flight path information of the first unmanned aerial vehicle reported by the first unmanned aerial vehicle, comprises:
receiving the flight path information of the first unmanned aerial vehicle reported by the first unmanned aerial vehicle upon completion of a target operation; wherein the target operation is an operation associated with an RRC connection between the first unmanned aerial vehicle and the base station;
wherein second RRC signaling is received with the flight path information of the first unmanned aerial vehicle reported by the first unmanned aerial vehicle upon the completion of the target operation, and wherein the second RRC signaling is user equipment (UE) assistance information signaling; or
wherein first medium access control (MAC) signaling is received with the flight path information of the first unmanned aerial vehicle reported by the first unmanned aerial vehicle upon the completion of the target operation.

20-23. (canceled)

24. The method of claim 13, wherein sending the flight path information of the first unmanned aerial vehicle to the second unmanned aerial vehicle, comprises:
broadcasting the flight path information of the first unmanned aerial vehicle with a system message; wherein the system message is a system information block (SIB) belonging to other system information (SI); or
receiving a request message sent by the second unmanned aerial vehicle;, wherein the request message is for requesting to obtain the flight path information of the first unmanned aerial vehicle, and broadcasting, based on the request message, the flight path information of the first unmanned aerial vehicle with a system message wherein the system message is an SIB belonging to other SI.

25-26. (canceled)

27. The method of claim 13, wherein sending the flight path information of the first unmanned aerial vehicle to the second unmanned aerial vehicle, comprises:
sending the flight path information of the first unmanned aerial vehicle to the second unmanned aerial vehicle with third RRC signaling; wherein the third RRC signaling is RRC reconfiguration signaling; or
sending the flight path information of the first unmanned aerial vehicle to the second unmanned aerial vehicle with second MAC signaling; wherein the second MAC signaling is for indicating the flight path information.

28-30. (canceled)

31. An information transmission method, performed by a second unmanned aerial vehicle and comprising:
receiving flight path information of a first unmanned aerial vehicle sent by a base station,
wherein the first unmanned aerial vehicle is an unmanned aerial vehicle that is to access the base station after performing cell reselection; and
performing, based on the flight path information of the first unmanned aerial vehicle, an operation to avoid a collision with the first unmanned aerial vehicle.

32. The method of claim 31, wherein
receiving the flight path information of the first unmanned aerial vehicle sent by the base station, comprises:
receiving, in response to determining that the base station is broadcasting a system message comprising the flight path information of the first unmanned aerial vehicle, the system message broadcast by the base station; and
reading the flight path information of the first unmanned aerial vehicle in the system message, wherein the system message is a system information block (SIB) belonging to other system information (SI); or
receiving the flight path information of the first unmanned aerial vehicle sent by the base station, comprises:
sending, in response to determining that the base station does not broadcast a system message comprising the flight path information of the first unmanned aerial vehicle, a request message to the base station, wherein the request message is for requesting to obtain the flight path information of the first unmanned aerial vehicle,
receiving the system message broadcast by the base station, and
reading the flight path information of the first unmanned aerial vehicle in the system message; wherein the system message is an SIB belonging to other SI.

33-34. (canceled)

35. The method of claim 31, wherein receiving the flight path information of the first unmanned aerial vehicle sent by the base station, comprises: receiving the flight path information of the first unmanned aerial vehicle sent by the base station with third RRC signaling; wherein the third RRC signaling is RRC reconfiguration signaling; or
receiving the flight path information of the first unmanned aerial vehicle sent by the base station with second MAC signaling; wherein the second MAC signaling is for indicating the flight path information.

36-41. (canceled)

42. A non-transitory computer readable storage medium, storing a computer program, wherein a computer performs the computer program is configured to implement the information transmission method of any one of claim 1.

43. A non-transitory computer readable storage medium, storing a computer program, wherein a computer performs the computer program to implement the information transmission method of claim 13.

44. A non-transitory computer readable storage medium, storing a computer program, wherein a computer performs the computer program to implement the information transmission method of claim 31.

45. An information transmission apparatus, comprising:
a processor; and
a memory configured to store instructions executable by the processor, and
wherein the processor is configured to perform the information transmission method of claim 1.

46. An information transmission apparatus, comprising:
a processor; and
a memory configured to store instructions executable by the processor, and
wherein the processor is configured to perform the information transmission method of claim 13.

47. An information transmission apparatus, comprising:
a processor; and
a memory configured to store instructions executable by the processor, and
wherein the processor is configured to perform the information transmission method of claim 31.
